(19) United States
(12) Patent Application Publication
(10) Pub. No.: US 2025/0218617 A1
(43) Pub. Date: Jul. 3, 2025

(54) OPTICAL CAVITY WITH ONE OR MORE INTRACAVITY LENSES, AND ASSOCIATED METHODS

(71) Applicant: THE UNIVERSITY OF CHICAGO, CHICAGO, IL (US)

(72) Inventors: David I. Schuster, Stanford, CA (US); Jonathan Simon, Palo Alto, CA (US); Matthew Scott Jaffe, Bozeman, MT (US)

(21) Appl. No.: 18/852,333

(22) PCT Filed: Mar. 27, 2023
(86) PCT No.: PCT/US2023/016393

§ 371 Date: Sep. 27, 2024

Related U.S. Application Data
(60) Provisional application No. 63/362,242, filed on Mar. 31, 2022.

(51) Int. Cl. G21K 1/00; G02B 17/00; G02B 26/00

(52) U.S. Cl. CPC G21K 1/00; G02B 17/004; G02B 26/001

(57) ABSTRACT

An optical cavity includes a plurality of mirrors that reflect light along a closed path. First and second mirrors of the plurality of mirrors define an optical axis therebetween. The optical cavity includes first and second lenses located between the first and second mirrors along the optical axis. A mode of the optical cavity has a waist located between the first and second intracavity lenses. Small values of the waist (e.g., <10 microns) produce large cooperativities that relax requirements for the cavity finesse (i.e., reflectivity of the mirrors). The mirrors may be retroreflecting to create a Fabry-Perot cavity. Alternatively, the first and second mirrors may define one segment of a ring cavity. The optical cavity may be used to trap, read, entangle, and drive nonlinear emitters (e.g., atoms, color centers, quantum dots) located near the waist.

### RELATED APPLICATIONS

This application claims priority to U.S. Provisional Patent Application No. 63/362,242, filed on Mar. 31, 2022, the entirety of which is incorporated herein by reference.

### BACKGROUND

Cavity quantum electrodynamics (cQED) is the study of the interaction between light and matter inside a resonant cavity. The matter may be an atom, ion, molecule, or other type of quantum particle that couples to light. The quantum particle may be trapped near the waist of an excited mode of the cavity, giving rise to intracavity optical tweezers.

### SUMMARY

In cavity quantum electrodynamics (cQED), it is frequently ideal to engineer the single-particle cooperativity η to be as large as possible. Defined as η=g²/κΓ, the cooperativity η quantifies the competition between (i) coherent information exchange at rate g between a cavity and an atom (e.g., a neutral atom or ion) located within the cavity and (ii) the decoherence rates Γ and κ of the atom and cavity, respectively. Increasing the cooperativity η increases the photon collection probability P_{c}=η/(1+η) that the atom emits into (or absorbs from) a mode of the cavity as opposed to free space. Increasing the cooperativity η also reduces the failure rate 2π/η^{1/2} of cavity-mediated quantum information transfer between two atoms trapped in separate optical cavities.

Another way to express the cooperativity is η≈0.2 [symbol] λ²/w₀², where [symbol] is the cavity finesse, w₀ is the diffraction-limited waist of the cavity mode, and λ is the wavelength of the atomic transition and cavity resonance. The finesse [symbol] can be interpreted as the number of round trips that light in the optical cavity makes before lost due to absorption, scatter, or transmission through a cavity mirror. This alternative expression for η can be interpreted geometrically: the resonant cross-section that an atom presents for absorption of light is ˜λ² and the area of the cavity mode going past the atom is ˜w₀². Therefore, for each pass of the cavity light past the atom, the absorption probability is ˜λ²/w₀². The optical cavity enhances this single-pass absorption probability by the number of passes [symbol] .

Prior-art optical cavities used for cQED achieve a high cooperativity η by employing a relatively large waist w₀ and very high finesse [symbol] . Such optical cavities (e.g., see FIG. 1) are typically fabricated using concave mirrors having very high reflectivities, typically greater than 99.999%. The highest finesses of nearly 10⁶ have been achieved by improving superpolishing and dielectric coatings of these mirrors. Due to their high finesse [symbol] , these prior-art optical cavities are challenging to align and stabilize. Furthermore, specialized handling techniques are needed to prevent airborne particulate matter (e.g., dust) from landing on the mirror surfaces; such contamination reduces the finesse [symbol] by increasing scatter. Similarly, mounting the optical cavity inside a vacuum chamber, as needed for atom trapping, puts stringent cleanliness requirements on the vacuum system to prevent contaminants (e.g., oil) from landing on the mirrors.

One aspect of the present embodiments is the realization that increasing the single-particle cooperativity η places no significant restrictions on the cavity length L. The idea that cQED requires a small mode volume V is a misnomer that arose by writing the Purcell factor as F_{P}=3λ³ Q/(4π²V). The Purcell factor F_{P} quantifies how much an emitter's spontaneous emission rate is enhanced when it is located inside a resonant cavity having quality factor Q. The expression makes small mode volume V seem advantageous to increasing the Purcell factor F_{P}, but ignores the fact that the Q drops as the cavity length L decreases. What is relevant for cQED is actually the finesse [symbol] =Qc/2Lf_{c}, where f_{c} is the resonant frequency of the cavity mode. When written in terms of the finesse [symbol] and assuming that the mode volume V˜Lw₀², the Purcell factor F_{P} is identical, up to unit factors, to the cooperativity η and therefore only depends on [symbol] , λ, and w₀. Thus, for a fixed value of λ there are only two independent experimental parameters that control the cooperativity η: the finesse [symbol] and the waist w₀.

The present embodiments include an optical cavity that uses intracavity lenses to achieve a waist w₀ that is smaller than that achieved with the prior-art optical cavities described above. Since η∝1/w₀², the smaller waist w₀ results in a significantly larger single-particle cooperativity η that may be used to lower the finesse [symbol] . For example, the optical cavity can generate a waist of w₀≈500 nm at λ=780 nm (the D₂ transition for Rb), yielding a cooperativity of η≈9.4 for a finesse of only [symbol] =20. This value of the cooperativity η is so large that an atom trapped near the waist emits a photon ten times faster into the optical cavity than into free space. When the atom is implemented as a qubit, the emitted photon has a greater-than-90% probability of being collected by the optical cavity. Furthermore, due to the lower finesse [symbol] , the cavity length L only needs to be stabilized to within λ/(2 [symbol] )=λ/20, making the optical cavity easier to align and stabilize than prior-art optical cavities. Also due to the lower finesse [symbol] , additional optical components can be placed within the cavity without significantly degrading the finesse [symbol] . The lower finesse [symbol] also eases requirements on handling, assembly, and vacuum cleanliness since an increase in optical scatter off of surface contaminants no longer significantly degrades the finesse [symbol] .

The increase in photon collection probability P_{c} will substantially improve state detection of tweezer-array apparatus and cQED setups. Accordingly, the present embodiments may be used to create a photonic-matter interface that efficiently converts quantum information between photonic qubits and matter-based qubits (e.g., trapped ions, neutral atoms, defects in diamond, etc.). Two of these interfaces could be used to optically couple matter-based qubits located in spatially separated traps or even separate vacuum systems. Such an optical coupling system could increase the number of qubits in a quantum computer, thereby improving qubit scaling. For example, the optical coupling setup could be used to efficiently transfer optical information between spatially disparate ion traps, thereby enabling quantum computing beyond the melting-size limit of a single ion crystal.

Another application of the present embodiments is sensing with color centers. Here, the optical cavity improves light gathering, thereby enabling faster, more accurate readout of the color center state. Such a scanning-cavity microscope would rely upon a small waist w₀ rather than high finesse, greatly relaxing material constraints. As another application, the optical cavity could be used for an orders-of-magnitude speed-up in state detection for atom-array quantum simulators and computers, thereby enabling optically-mediated non-local gates and real-time feedback-based error correction.

### BRIEF DESCRIPTION OF THE FIGURES

FIG. 1 is a side view of prior-art optical cavity.

FIG. 2 is a stability curve for the optical cavity of FIG. 1.

FIG. 3 is a side view of an optical cavity that can advantageously achieve a smaller waist w₀ than the prior-art optical cavity of FIG. 1, in an embodiment.

FIG. 4 is a stability curve for the optical cavity of FIG. 3.

FIG. 5 shows a ringdown trace obtained experimentally with the optical cavity of FIG. 3.

FIG. 6 is a side view of an optical cavity that is similar to the optical cavity of FIG. 3 except that it uses curved mirrors, in an embodiment.

FIG. 7 is a side view of an optical cavity that is similar to the optical cavity of FIG. 3 except that intracavity lenses are mounted inside a vacuum chamber, in an embodiment.

FIG. 8 is a side view of an optical cavity that is similar to the optical cavity of FIG. 3 except one of the intracavity lenses and planar mirrors are replaced with a curved mirror, in an embodiment.

FIG. 9 is a side view of an optical cavity that is similar to the optical cavity of FIG. 3 except that the second intracavity lens and second mirror have been replaced with a planar mirror that is positioned near the waist, in an embodiment.

FIG. 10 illustrates a method for driving any of the optical cavities described herein, in embodiments.

FIG. 11 is a side view of an optical cavity that is similar to the optical cavity of FIG. 3 except that it has a traveling-wave mode instead of a standing-wave mode, in embodiments.

FIG. 12 is a side view of an optical ring cavity that is similar to the optical ring cavity of FIG. 11 except that it uses focusing mirrors instead of planar mirrors and lenses, in embodiments.

FIG. 13 is a side view of an optical cavity that is similar to the optical ring cavity of FIG. 12 except that it uses two retroreflecting planar mirrors to create a Fabry-Perot cavity, in embodiments.

FIG. 14 is a side view of an optical cavity that is a half-version of the optical cavity of FIG. 13, in an embodiment.

### DETAILED DESCRIPTION

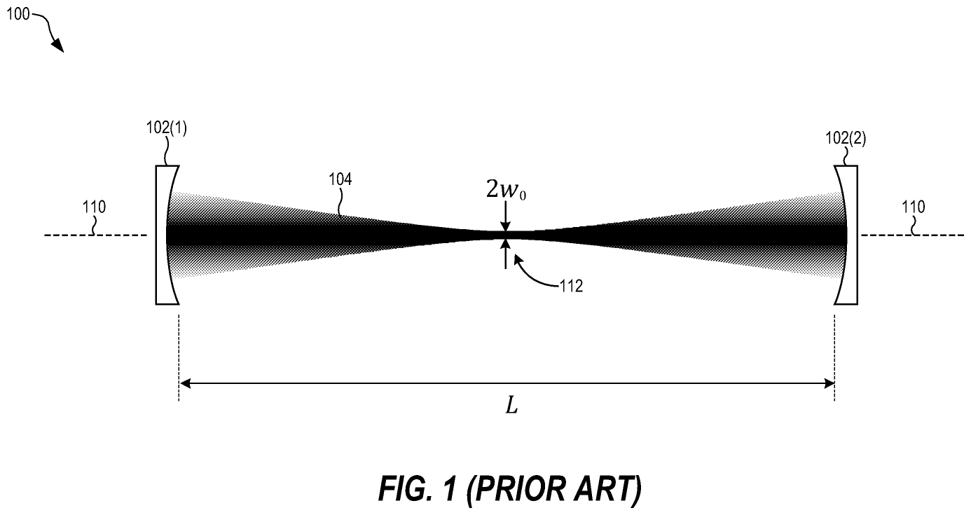

FIG. 1 is a side view of prior-art optical cavity 100 formed from a first mirror 102(1) and a second mirror 102(2). The mirrors 102(1) and 102(2) are counterfacing, thereby defining an optical axis 110 therebetween. For clarity in the following discussion, the mirrors 102(1) and 102(2) are assumed to have the same radius of curvature R. Therefore, the optical cavity 100 is confocal when a cavity length L between the mirrors 102(1) and 102(2) equals the radius of curvature R. For clarity herein, the term “longitudinal” refers to the direction parallel to the optical axis 110 while the term “transverse” refers to one or both of the directions perpendicular to the optical axis 110.

Resonant light coupled into the optical cavity 100 can excite a cavity mode 104 having a diffraction-limited waist w₀ that is located between the mirrors 102(1) and 102(2). The waist w₀ is the minimum 1/e² intensity radius of the cavity mode 104 and is therefore the location of the highest peak intensity of the cavity mode 104. Along the optical axis 110, the waist Wo occurs at a focal point 112. For confocality (i.e., L=R), the focal point 112 occurs midway between the mirrors 102(1) and 102(2).

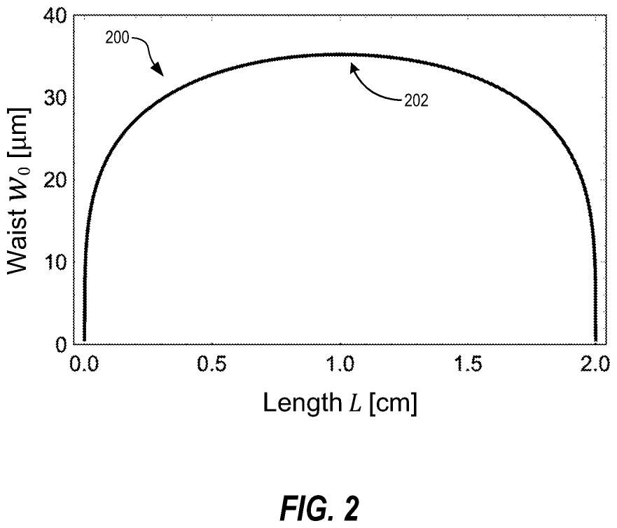

FIG. 2 is a stability curve 200 showing how the waist w₀ of the cavity mode 104 varies with the cavity length L for the optical cavity 100 of FIG. 1. It is assumed in FIG. 2 that R=1 cm. At confocality (see the confocality point 202), the waist w₀ has its largest value of w₀=\sqrt{Rλ/2π}, where λ is the wavelength of the mode 104. Numerically, w₀≈35 μm at λ=780 nm (i.e., the wavelength of the rubidium D₂ line). The waist w₀ can be decreased by moving the mirrors 102(1) and 102(2) away from confocality, i.e., either closer to each other (L<R) or away from each other (L>R). However, operating the optical cavity 100 away from confocality increases sensitivity to misalignments and aberrations. This sensitivity can be seen in FIG. 2 by the increasing steepness of the stability curve 200 as L approaches 0 and 2 cm. For a waist w₀ less than ˜10 μm, this sensitivity makes the optical cavity 100 impractical to use.

One way to increase the cooperativity η∝ [symbol] & λ²/w² is to decrease the waist w₀. This can be achieved with the optical cavity 100 by decreasing the radius of curvature R of the mirrors 102(1) and 102(2). However, due to limitations in fabrication (i.e., machining, turning, polishing, etc.), R is typically greater than or equal to 1 cm. Another way to increase the cooperativity η is to increase the finesse [symbol] . This can be achieved with the optical cavity 100 by increasing the reflectivity of the mirrors 102(1) and 102(2). However, very high values of finesse [symbol] require exceptionally clean optical surfaces since scatter from dust and other particulates degrades the finesse [symbol] . As a result, the mirrors 102(1) and 102(2) must be carefully handled in a dust-free environment (e.g., a cleanroom) and operated inside a vacuum chamber.

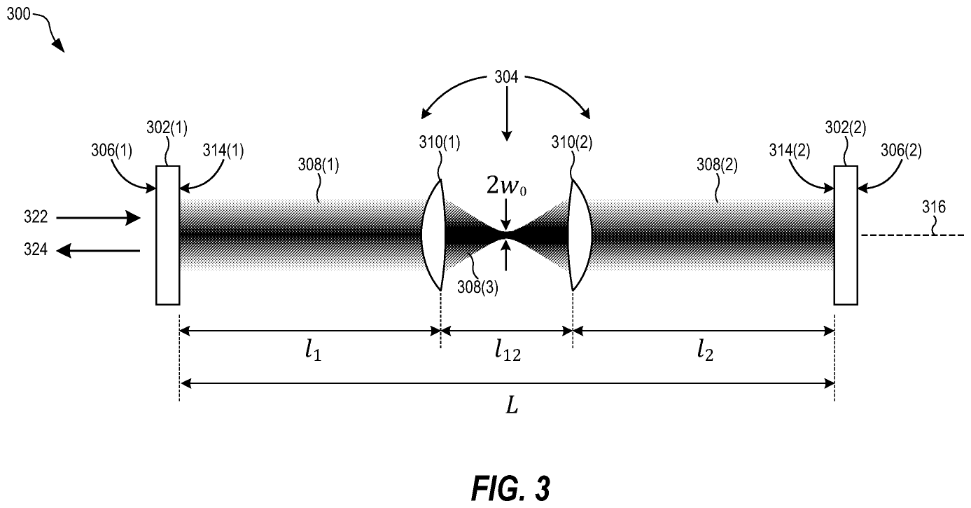

FIG. 3 is a side view of an optical cavity 300 that can advantageously achieve a smaller waist w₀ than the prior-art optical cavity 100 of FIG. 1. The optical cavity 300 includes a first mirror 302(1) having a first front face 314(1) and a first rear face 306(1). The optical cavity 300 also includes a second mirror 302(2) having a second front face 314(2) and a second rear face 306(2). Deposited on the front faces 314(1) and 314(2) are reflective coatings, such as a layer of metal or a dielectric stack. The mirrors 302(1) and 302(2) are separated by a cavity length L and are counterfacing to define an optical axis 316 therebetween. The optical cavity 300 also includes a first intracavity lens 310(1) and a second intracavity lens 310(2). Each of the lenses 310(1) and 310(2) is “intracavity” in that it is located longitudinally (i.e., parallel to the optical axis 316) between the front faces 314(1) and 314(2). Specifically, the first intracavity lens 310(1) is located approximately a first distance l₁ in front of the first front face 314(1) while the second intracavity lens 310(2) is located approximately a second distance l₂ in front of the second front face 314(2). The intracavity lenses 310(1) and 310(2) are longitudinally separated by a lens-lens distance/l₂. Thus, the cavity length L≈l₁+l₂+l₂.

The optical cavity 300 has a cavity mode 304 with a first section 308(1) that extends longitudinally between the first front face 314(1) and the first intracavity lens 310(1), a second section 308(2) that extends longitudinally between the second front face 314(2) and the second intracavity lens 310(2), and a center section 308(3) that extends longitudinally between the first intracavity lens 310(1) and the second intracavity lens 310(2).

In FIG. 3, each of the mirrors 302(1) and 302(2) is a planar mirror and the intracavity lenses 310(1) and 310(2) are longitudinally separated by the sum of their focal lengths. In this case, the first section 308(1) is approximately collimated, meaning that its 1/e² intensity radius varies negligibly along the optical axis 316. The second section 308(2) is also approximately collimated. However, the center section 308(3) is focused, forming a waist w₀ that is longitudinally located between the intracavity lenses 310(1) and 310(2).

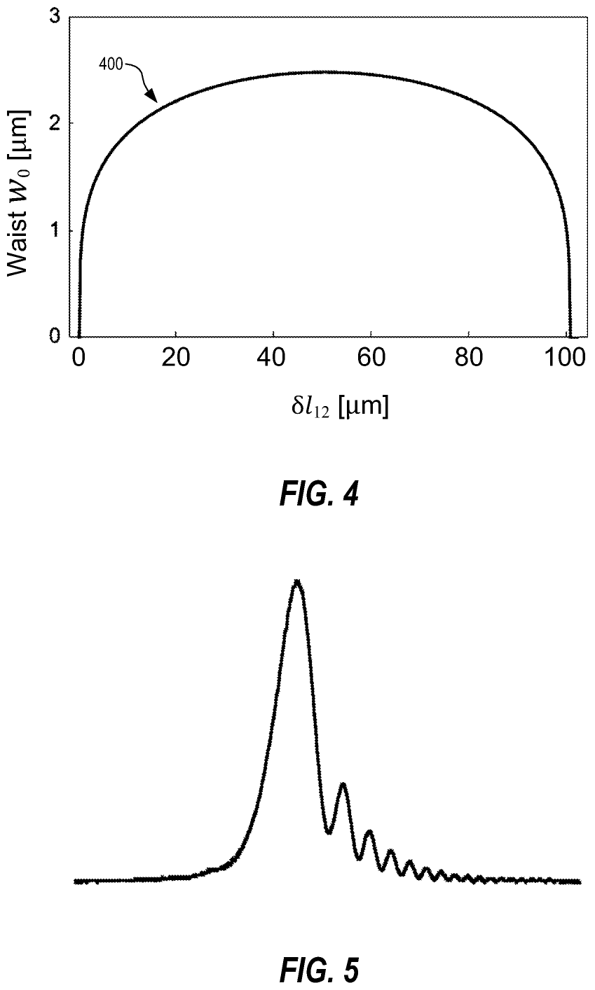

FIG. 4 is a stability curve 400 showing how the waist Wo of the cavity mode 304 varies with deviation δl₁₂ of l₁₂ for the optical cavity 300 of FIG. 3. Specifically, δl₁₂=(EFL₁+EFL₂)−l₁₂, where EFL₁ is the effective focal length of the first intracavity lens 310(1) and EFL₂ is the effective focal length of the second intracavity lens 310(2). In FIG. 4, it is assumed that (i) each of the intracavity lenses 310(1) and 310(2) is an aspheric lens with an EFL of 1 cm, (ii) l₁=l₂=1 m, and (iii) λ=780 nm. When the lenses 310(1) and 310(2) are separated by EFL₁+EFL₂ (i.e., δl₂=0), the optical cavity 300 is not stable. At the center of the stability curve 400, where the lenses 310(1) and 310(2) are separated by slightly less than EFL₁+EFL₂≈1.995 cm, the waist w₀ has its greatest value of ˜2.5 μm, more than ten times smaller than the 35-μm waist w₀ that the prior-art optical cavity 100 achieves when operating at confocality (see FIG. 2). The stability curve 400 also shows that the optical cavity 300 can achieve waists less than 1 μm, albeit with an increased sensitivity to misalignments and aberrations. Thus, the optical cavity 300 can achieve single-particle cooperativities η that are more than 100 times greater than what the optical cavity 100 can achieve.

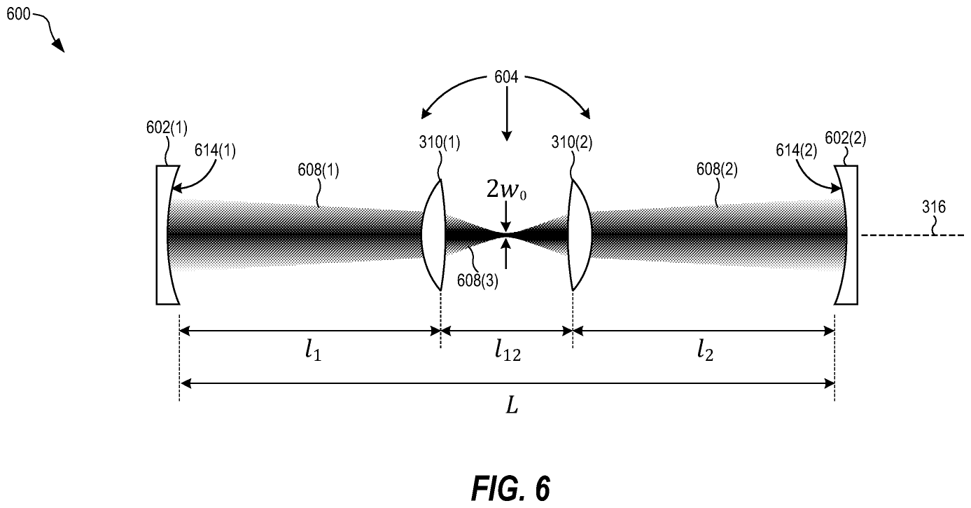

One advantage of the optical cavity 300 is that the mirrors 302(1) and 302(2) can be planar. Planar mirrors are easier to manufacture and procure than curved mirrors. In the prior-art optical cavity 100 of FIG. 1, replacing the curved mirrors 102(1) and 102(2) with planar mirrors would make the optical cavity 100 highly sensitive to misalignment and mechanical drift. For this reason, many prior-art cavities avoid planar mirrors. However, in the optical cavity 300, the intracavity lenses 310(1) and 310(2) provide immunity to such misalignment and drift. Accordingly, the mirrors 302(1) and 302(2) can be planar, as shown in FIG. 3. However, one or both of the mirrors 302(1) and 302(2) may be curved (see FIG. 6).

The dramatic increase in cooperativity η that can be achieved with the optical cavity 300 may be used to reduce the finesse [symbol] , thereby avoiding many of the challenges of working with the high-reflectivity mirrors used to make high-finesse cavities. In some embodiments, the finesse [symbol] of the optical cavity 300 is less than 100. Such low finesses can be achieved with conventional mirrors that are readably available and do not require superpolishing. Compared to their high-finesse counterparts, low-finesse cavities are also less susceptibility to loss arising from dust and particulate matter landing on the mirror surfaces. Accordingly, the mirrors 302(1) and 302(2) do not need to be placed in vacuum or handled differently from conventional mirrors.

FIG. 5 shows a ringdown trace obtained experimentally with the optical cavity 300 of FIG. 3. In this experiment, each of the intracavity lenses 310(1) and 310(2) was a fused-silica aspherical lens having superpolished faces that were anti-reflection-coated at 780 nm. Single-pass transmission through each of these lenses exceeded 99.9%. When combined with high-reflectivity mirrors, the finesse [symbol] can easily exceed 10⁴. For example, the ringdown trace shown in FIG. 5 is consistent with a finesse [symbol] =18,400±150.

In general, the size of the waist w₀ depends on the numerical aperture (NA) of the intracavity lenses 310(1) and 310(2). In one embodiment, each of the lenses 310(1) and 310(2) is a microscope objective, which can advantageously achieve NAs up to 0.9. Thus, microscope objectives can generate some of the smallest waists. However, because microscope objectives have multiple optical elements, they produce greater intracavity loss when compared to lenses with fewer elements, even when these optical elements are superpolished and anti-reflection coated. Typically, an anti-reflection-coated objective has a single-pass loss of at least 10%, which limits the highest finesse to F˜18.

In general, each of the intracavity lenses 310(1) and 310(2) can be any type of lens or lens assembly known in the art. Examples include, but are not limited to, biconvex lenses, plano-convex lenses, doublets (e.g., achromats), triplets, and Fresnel lenses. The lenses 310(1) and 310(2) may be of the same type or different types. Where the lenses 310(1) and 310(2) are of the same type, they may have different parameters (e.g., numerical aperture, focal length, clear aperture, etc.), similar parameters, or a combination thereof. Thus, while FIG. 3 shows the lenses 310(1) and 310(2) having the same focal length f₀, the lenses 310(1) and 310(2) may alternatively have different focal lengths. In this case, the longitudinal position of the waist w₀ will shift towards the lens with the shorter focal length.

One or both of the mirrors 302(1) and 302(2) may serve as a coupler. For example, in FIG. 3, input light 322 is transmitted through the first mirror 302(1) to couple into the optical cavity 300. When the input light 322 has a frequency approximately equal to the resonant frequency of the mode 304, it will excite the cavity mode 304. Similarly, leakage light 324 can couple out of the optical cavity 300 by transmitting through the first mirror 302(1). The leakage light 324 may be used for diagnostics or measurements. For example, it may be imaged with a camera, detected, or used to lock the frequency of the input light 322 to a cavity resonance. To enhance transmission of the input light 322 and leakage light 324 through the first mirror 302(1), it may be fabricated on an optically transparent substrate. Furthermore, the rear face 306(1) may be polished, anti-reflection coated, or both. Although not shown in FIG. 3, the second mirror 302(2) may additionally or alternatively serve as a coupler. Therefore, the mirrors 302(1) and 302(2) may have the same reflectivity or different reflectivities.

In FIG. 3, the intracavity lenses 310(1) and 310(2) are longitudinally positioned such that l₁≈l₂. In conjunction with the equal focal lengths of the lenses 310(1) and 310(2), the waist w₀ is longitudinally located midway between the front faces 314(1) and 314(2). However, the intracavity lenses 310(1) and 310(2) may be longitudinally positioned elsewhere (e.g., l₁<l₂ or l₁>l₂), in which case the location of the waist w₀ will shift accordingly.

FIG. 6 is a side view of an optical cavity 600 that is similar to the optical cavity 300 of FIG. 3 except that it uses curved mirrors (e.g., spherical curved mirrors). Specifically, the optical cavity 600 includes a first mirror 602(1) having a first concave front face 614(1) and a second mirror 602(2) having a second concave front face 614(2). The optical cavity 600 supports a cavity mode 604 having a first section 608(1) that extends longitudinally between the first concave front face 614(1) and the first intracavity lens 310(1), a second section 608(2) that extends longitudinally between the second concave front face 614(2) and the second intracavity lens 310(2), and a center section 608(3) that extends longitudinally between the first intracavity lens 310(1) and the second intracavity lens 310(2). Due to the curvature of the first mirror 602(1), the first section 608(1) is not collimated, meaning that its 1/e² intensity radius varies non-negligibly along the optical axis 316. The second section 608(2) is also not collimated. Similar to the center section 308(3) shown in FIG. 3, the center section 608(3) is focused, forming a waist w₀ that is longitudinally located between the first intracavity lens 310(1) and the second intracavity lens 310(2). The concave front faces 614(1) and 614(2) may have the same radius or curvature or different radii of curvature.

In one embodiment, one or both of the curved mirrors 602(1) and 602(2) is replaced with a planar mirror and lens. One or more additional lenses (e.g., a telescope or beam expander) may be placed between the first mirror 602(1) and first lens 310(1) to further shape the cavity mode 604. Similarly, one or more additional lenses may be placed between the second mirror 602(2) and first lens 310(2).

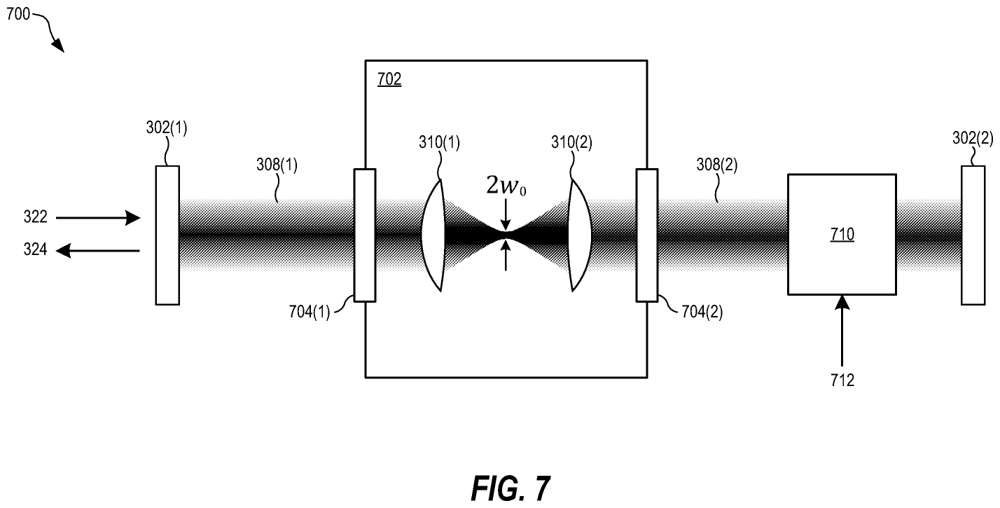

FIG. 7 is a side view of an optical cavity 700 that is similar to the optical cavity 300 of FIG. 3 except that the intracavity lenses 310(1) and 310(2) are mounted inside a vacuum chamber 702. For cavity QED experiments and set-ups that use cold atoms, the waist w₀ will likely need to occur inside in an ultra-high vacuum environment for trapping. However, some conventional vacuum chambers are so large that the intracavity lenses 310(1) and 310(2) cannot be placed outside of the vacuum chamber, as they will then be too far apart from each other to produce a waist w₀ small enough for the application at hand. In such situations, the lenses 310(1) and 310(2) can be brought closer to each other by mounting them inside the vacuum chamber, as shown in FIG. 7. Since the first section 308(1) of the mode 304 is approximately collimated, the first mirror 302(1) can be placed far from the first intracavity lens 310(1) without significantly affecting the stability of the optical cavity 700 or the size of the waist w₀. Similarly, the second mirror 302(2) can be placed far from the second intracavity lens 310(2).

Advantageously, placing the mirrors 302(1) and 302(2) outside of the vacuum chamber 702 allows them to be easily adjusted for alignment. For example, each of the mirrors 302(1) and 302(2) may be mounted on a conventional mirror mount with tip and tilt adjustment. By comparison, most prior-art optical cavities that use concave mirrors (e.g., the optical cavity 100 of FIG. 1) are mounted completely inside a vacuum chamber, thereby requiring ultrahigh-vacuum-compatible translation stages and actuators for alignment.

To allow light to pass through, the vacuum chamber 702 may include a first window 704(1) and second window 704(2). One or both of the windows 704(1) and 704(2) may be anti-reflection coated to reduce intracavity loss that lowers finesse [symbol] . In another embodiment, only one of the intracavity lenses 310(1) and 310(2) is located inside the vacuum chamber 702, the other being located outside the vacuum chamber 702. In another embodiment, both of the lenses 310(1) and 310(2) are located outside of the vacuum chamber 702 such that the waist w₀ is located inside the vacuum chamber 702.

In some embodiments, the optical cavity 700 includes an intracavity modulator 710 that, when electrically driven with a modulation signal 712, modulates the light within the optical cavity 700. The modulator 710 may be used, for example, to integrate the optical cavity 700 with an optical communication system (not shown). The modulator 710 may be an acousto-optic modulator, electro-optic modulator, spatial-light modulator, or similar type of electrically-controlled nonlinear optical device. In the example of FIG. 7, the modulator 710 is located in the second section 308(2) of the cavity mode 304, outside of the vacuum chamber 702. Alternatively, the modulator 710 may be located in the first section 308(1), outside of the vacuum chamber. Alternatively, the modulator 710 may be located within the vacuum chamber 702 (either in the first section 308(1) or the second section 308(2). While FIG. 7 shows the optical cavity 700 having only the one modulator 710, the optical cavity 700 may alternatively have more than one modulator. In other embodiments, the optical cavity 700 additionally or alternatively includes one or more other optical components (e.g., waveplates, phase plates, polarization rotators, q-switchers, filters, etc.).

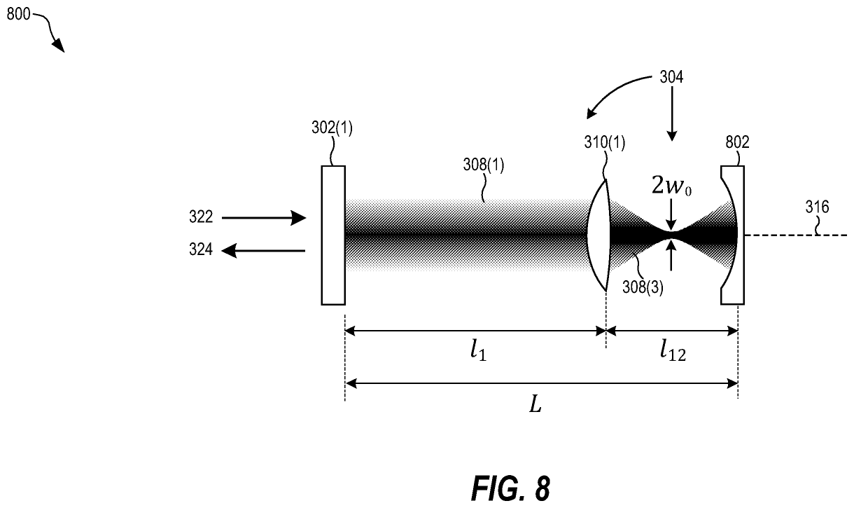

FIG. 8 is a side view of an optical cavity 800 that is similar to the optical cavity 300 of FIG. 3 except that the second intracavity lens 310(2) and second mirror 302(2) have been replaced with a curved mirror 802. In this case, the cavity mode 304 only has the first section 308(1) and the second section 308(2). Accordingly, the cavity length L of the optical cavity 800 is only given by the sum of the distances l₁ and l₁₂. As shown in FIG. 8, input light 322 may be coupled into the optical cavity 800 through the first mirror 302(1) and leakage light 324 may couple out of the optical cavity 800 through the first mirror 302(1). Alternatively, input light 322 may be coupled into the optical cavity 800 through the curved mirror 802 and leakage light 324 may couple out of the optical cavity 800 through the curved mirror 802.

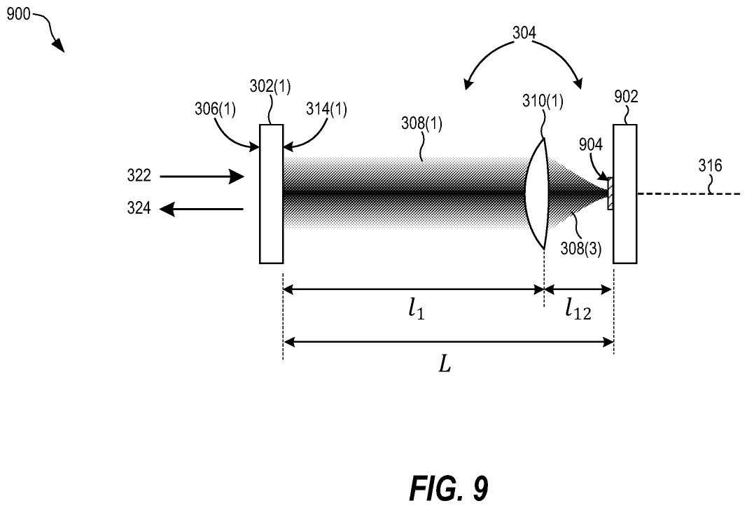

FIG. 9 is a side view of an optical cavity 900 that is similar to the optical cavity 300 of FIG. 3 except that the second intracavity lens 310(2) and second mirror 302(2) have been replaced with a planar mirror 902 that is positioned near the waist. Affixed to the front face of the planar mirror 902 is a sample of nonlinear emitters 904. Examples of such nonlinear emitters include, but are not limited to, quantum dots and solid-state color centers (e.g., silicon vacancy centers in diamond, nitrogen vacancy centers in diamond, etc.). Advantageously, no trapping techniques are needed to confine the nonlinear emitters 904 at this position (as opposed to atoms that must be magnetically or optically trapped away from such surfaces).

In FIG. 9, the cavity mode 304 only has the first section 308(1) and the second section 308(2). Accordingly, the cavity length L of the optical cavity 900 is only given by the sum of the distances l₁ and l₁₂ (i.e., l₂=0). As shown in FIG. 9, input light 322 may be coupled into the optical cavity 900 through the first mirror 302(1) and leakage light 324 may couple out of the optical cavity 900 through the first mirror 302(1). Alternatively, input light 322 may be coupled into the optical cavity 900 through the planar mirror 902 and leakage light 324 may couple out of the optical cavity 900 through the planar mirror 902.

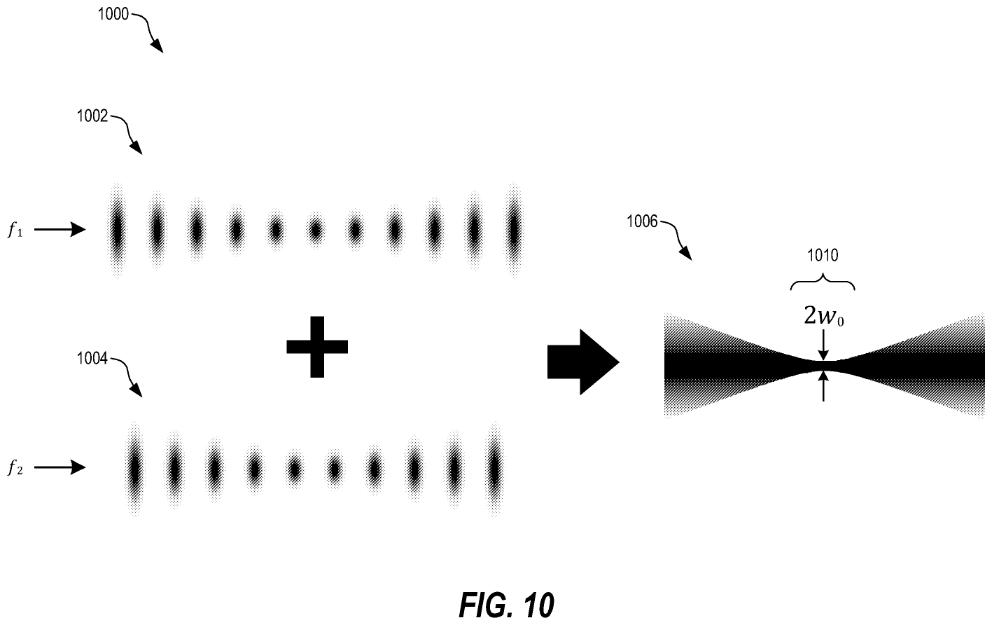

FIG. 10 illustrates a method 1000 for driving any of the optical cavities described herein. The method 1000 includes simultaneously coupling first and second optical frequency components into the optical cavity. The first frequency component has a first frequency f₁ and excites a first longitudinal mode of the optical cavity. The time-averaged mode structure of the first longitudinal mode has the form of a first standing wave 1002. The second frequency component has a second frequency f₂ and excites a second longitudinal mode of the optical cavity. The time-averaged mode structure of the second longitudinal mode also has the form of a second standing wave 1004, however the longitudinal positions of the antinodes may be shifted from those of the first standing wave 1002.

Since the first and second longitudinal modes are excited simultaneously, interference terms between the first and second longitudinal modes affect time-averaging. In this case, a time-averaged mode structure 1006 of the combined first and second longitudinal modes is longitudinally smooth, i.e., no longer exhibits a standing-wave pattern. Instead, the mode structure 1006 has only one potential minimum for trapping atoms (i.e., at the waist w₀), similar to a traveling-wave optical dipole trap. For this reason, the mode structure 1006 is also referred to herein as an intracavity optical dipole trap 1010. By comparison, each of the standing waves 1002 and 1004 has several potential minima that prevents atoms trapped in these different potential minima from interacting with each other (e.g., via collisions).

In one embodiment, the first and second optical frequency components excite two adjacent longitudinal modes of the optical cavity. Here, “adjacent” means that the first longitudinal mode is characterized by a first integer mode number n₁ and the second longitudinal mode is characterized by a second integer mode number n₂, where n₂=n₁+1 or n₂=n₁−1. Thus, the resonant frequencies of the two adjacent longitudinal modes differ by approximately one free-spectral range of the cavity. In other embodiments, the first and second longitudinal modes are not adjacent.

The first and second optical frequency components may be two frequency components of a single laser beam. Alternatively, the first and second optical frequency components may be two separate monochromatic (i.e., single frequency) laser beams. For example, a first monochromatic laser beam may be coupled into the optical cavity through the first mirror 302(1) while a second monochromatic laser beam is coupled into the optical cavity through the second mirror 302(2). Furthermore, the longitudinally smooth mode structure 1006 can be produced by simultaneously exciting more than two longitudinal modes of the optical cavity. For example, a single monochromatic laser beam can be modulated (e.g., amplitude, phase, or frequency modulated) at the free spectral range of the optical cavity to simultaneously excite several adjacent longitudinal modes.

The optical cavities of FIGS. 3 and 6-8 are retroreflecting cavities in which the cavity modes are standing waves. In other embodiments, the optical cavity may be a ring cavity in which the modes are traveling waves. Advantageously, traveling-wave cavities create longitudinally smooth mode structures using only one laser frequency. In such embodiments, one “arm” of the ring cavity may include the intracavity lenses 310(1) and 310(2) to create the waist w₀ of the traveling-wave mode. The ring cavity may be a three-mirror ring cavity, a four-mirror ring cavity, a four-mirror bow-tie cavity, or another type of ring cavity known in the art.

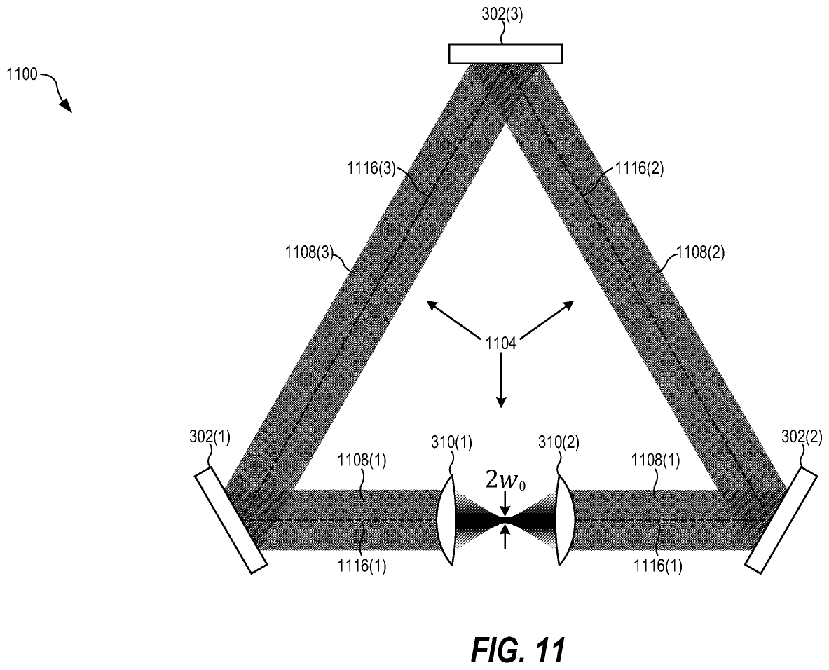

FIG. 11 is a side view of an optical ring cavity 1100 that is similar to the optical cavity of FIG. 3 except that it has a traveling-wave mode 1104 (as opposed to the standing-wave mode 304). The ring cavity 1100 is formed from a plurality of mirrors 302 that are positioned and oriented to reflect light along a closed path. Specifically, the ring cavity 1100 combines the first mirror 302(1) and second mirror 302(2) of FIG. 3 with a third mirror 302(3). Like all ring cavities, at least part of the closed path in FIG. 11 is not formed via retroreflection (as opposed to the Fabry-Perot cavity geometries shown in FIGS. 3 and 6-8). This closed path defines the edges of a triangle. In other embodiments, the optical ring cavity 1100 includes four or more mirrors 302 that reflect light in a closed path that defines edges of another type of polygon (e.g., square, trapezoid, hexagon, etc.), either regular or irregular. For four or more mirrors 302, the closed path may have a bow-tie geometry.

Neighboring pairs of the mirrors 302 define an optical axis therebetween. The closed path has a plurality of “arms”, each extending along the optical axis of each neighboring pair of mirrors 302. For example, in FIG. 11 the optical ring cavity 1100 has a first arm 1108(1) that extends between the mirrors 302(1) and 302(2) along a first optical axis 1116(1), a second arm 1108(2) that extends between mirrors 302(2) and 302(3) along a second optical axis 1116(2), and a third arm 1108(3) that extends between the mirrors 302(3) and 302(1) along a third optical axis 1116(3). The intracavity lenses 310(1) and 310(2) are located in the first arm 1108(1) where the waist w₀ of the traveling-wave mode 1104 occurs. The ring cavity 1100 will have additional arms 1108 and optical axes 1116 in embodiments with more than three mirrors 302. While the mirrors 302 are shown in FIG. 11 as planar, one or more of the mirrors 302 may be curved (e.g., similar to the mirrors 602 in FIG. 6). The optical ring cavity 1100 may also be used with a vacuum chamber (e.g., similar to the vacuum chamber 702 in FIG. 7). A modulator may be included in any of the arms 1108 (e.g., similar to the modulation 710 in FIG. 7).

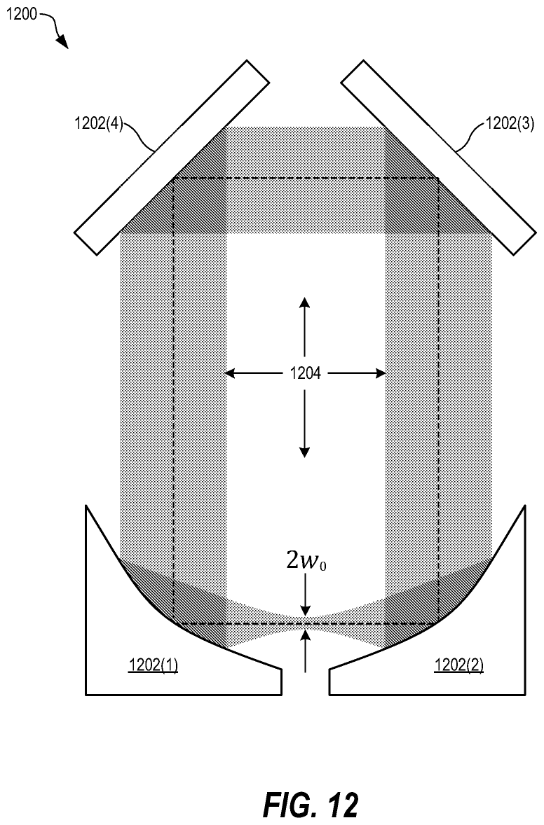

FIG. 12 is a side view of an optical ring cavity 1200 that is similar to the optical ring cavity of FIG. 11 except that it uses focusing mirrors instead of planar mirrors and lenses. Specifically, the optical ring cavity 1200 includes a first focusing mirror 1202(1) that replaces the first mirror 302(1) and first intracavity lens 310(1) of FIG. 11. Similarly, the optical ring cavity includes a second focusing mirror 1202(2) that replaces the second mirror 302(2) and second intracavity lens 302(2) of FIG. 11. In the example of FIG. 12, each of the focusing mirrors 1202(1) and 1202(2) is an off-axis parabolic mirror shaped for 90° off-axis reflection. However, one or both of the focusing mirrors 1202(1) and 1202(2) may be shaped for off-axis reflection at another angle (e.g., 30°, 45°, 60°, etc.). One or both of the focusing mirrors 1202(1) and 1202(2) may be another type of focusing mirror known in the art. Examples of other types of focusing mirrors include, but are not limited to, on-axis parabolic mirrors, spherical (concave) mirrors, and aspherical mirrors.

In the example of FIG. 12, the optical ring cavity 1200 includes a third mirror 1202(3) and a fourth mirror 1202(4) that are both planar and oriented to reflect at 90°. The focusing mirrors 1202(1) and 1202(2) and planar mirrors 1202(3) and 1202(4) form a ring cavity with four legs that support a travelling-wave mode 1204 whose waist is located between the focusing mirrors 1202(1) and 1202(2). In one embodiments, the optical ring cavity 1200 includes three mirrors: two off-axis parabolic mirrors shaped for 60° reflection and one planar mirror. In other embodiments, the optical ring cavity 1200 includes more than four mirrors (and legs). In another embodiment, one of the focusing mirrors 1202(1) and 1202(2) is replaced with a planar mirror (e.g., one of the mirrors 302) and lens (e.g., one of the intracavity lenses 310).

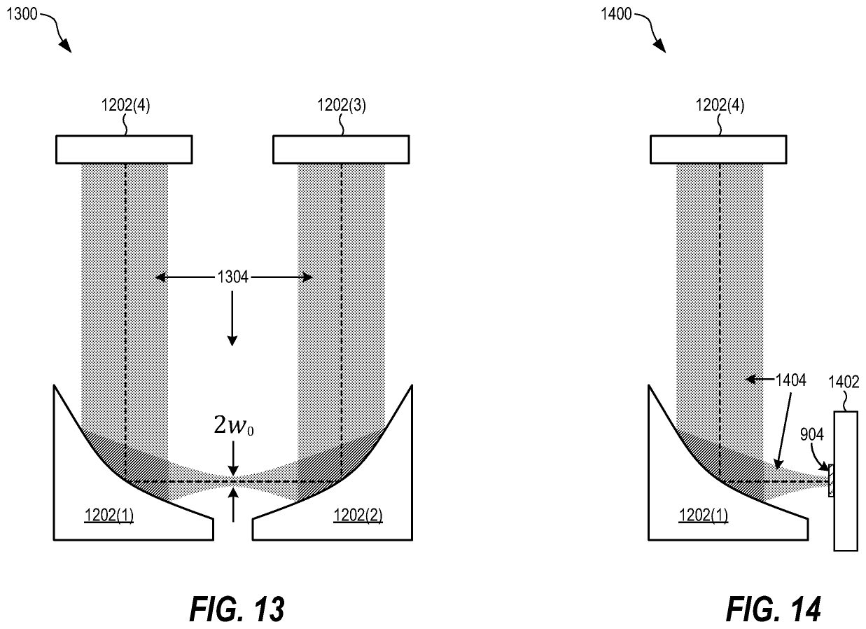

FIG. 13 is a side view of an optical cavity 1300 that is similar to the optical ring cavity of FIG. 12 except that the mirrors 1202(3) and 1202(4) are retroreflecting. As a result, the optical cavity 1300 is a Fabry-Perot cavity that supports a standing-wave mode 1304. As a Fabry-Perot cavity, the optical cavity 1300 may be used similarly to the optical cavity 300 of FIG. 3 and the optical cavity 700 of FIG. 7. For example, the optical cavity 1300 may be used with the method 1000 of FIG. 10 to create a longitudinally smooth optical dipole trap.

FIG. 14 is a side view of an optical cavity 1400 that is a half-version of the optical cavity 1300 of FIG. 13. Specifically, the optical cavity 1400 includes a retroreflecting planar mirror 1402 that is located at the waist w₀ of a standing-wave mode 1404. The planar mirror 1402 replaces the second focusing mirror 1202(2) and third mirror 1202(3). As shown in FIG. 14, a sample of nonlinear emitters 904 may be affixed to the front face of the planar mirror 902. Accordingly, the optical cavity 1400 may be used similarly as the optical cavity 900 of FIG. 9.

### Combinations of Features

Features described above as well as those claimed below may be combined in various ways without departing from the scope hereof. The following examples illustrate possible, non-limiting combinations of features and embodiments described above. It should be clear that other changes and modifications may be made to the present embodiments without departing from the spirit and scope of this invention:

(A1) An optical cavity includes a plurality of mirrors positioned to reflect light along a closed path. First and second mirrors of the plurality of mirrors define an optical axis therebetween. The optical cavity also includes first and second intracavity lenses located along the optical axis. A mode of the optical cavity has a waist located between the first and second intracavity lenses.

(A2) In the optical cavity denoted (A1), the finesse is 1000 or less.

(A3) In either of the optical cavities denoted (A1) and (A2), the waist is ten microns or less.

(A4) In any of the optical cavities denoted (A1) to (A3), the first and second intracavity lenses have a similar numerical aperture.

(A5) In any of the optical cavities denoted (A1) to (A4), each of the first and second intracavity lenses is a microscope objective or an aspheric lens.

(A6) In any of the optical cavities denoted (A1) to (A5), each of the first and second intracavity lenses has at least one surface that is anti-reflection coated at a wavelength of the light.

(A7) In any of the optical cavities denoted (A1) to (A6), one or both of the first and second intracavity lenses having a numerical aperture greater than or equal to 0.5.

(A8) In any of the optical cavities denoted (A1) to (A7), the plurality of mirrors includes three or more mirrors forming a ring cavity.

(A9) In any of the optical cavities denoted (A1) to (A7), the first and second mirrors forming a Fabry-Perot cavity.

(A10) In the optical cavity denoted (A9), the first mirror and first intracavity lens are separated by a first distance. The second mirror and second intracavity lens are separated by a second distance that is different than the first distance.

(A11) In either one of the optical cavities denoted (A9) and (A10), one or both of the first and second mirrors is planar.

(A12) In any of the optical cavities denoted (A9) to (A11), the first mirror includes a substrate with opposing front and rear surfaces that are polished. The first mirror also includes a high-reflectivity coating applied to the front surface.

(A13) In the optical cavity denoted (A12), the first mirror includes an anti-reflection coating on the rear surface.

(A14) In any of the optical cavities denoted (A1) to (A13), the optical cavity further includes a translation stage that, when actuated, translates the first intracavity lens transversely to the optical axis.

(A15) In any of the optical cavities denoted (A1) to (A14), the optical cavity further includes a second translation stage that, when actuated, translates the second intracavity lens transversely to the optical axis.

(A16) In any of the optical cavities denoted (A1) to (A15), the optical cavity further includes a vacuum chamber within which the first and second intracavity lenses are mounted.

(A17) In the optical cavity denoted (A16), the vacuum chamber includes a first vacuum window located between the first intracavity lens and the first mirror. The vacuum chamber also includes a second vacuum window located between the second intracavity lens and the second mirror. The first and second mirrors are located outside of the vacuum chamber.

(B1) A method for cavity quantum electrodynamics includes confining one or more nonlinear emitters near the waist of any of the optical cavities denoted (A1) to (A17).

(B2) In the method denoted (B1), the one or more nonlinear emitters are selected from the group consisting of: atoms, solid-state color centers, and quantum dots.

(B3) In either of the methods denoted (B1) and (B2), the method further includes reading out the one or more nonlinear emitters using the optical cavity.

(B4) In any of the methods denoted (B1) to (B3), the method further includes entangling the one or more nonlinear emitters with a photon that is coupled into the optical cavity.

(B5) In any of the methods denoted (B1) to (B4), the method further includes driving the one or more nonlinear emitters to deterministically generating a single photon that is emitted into a mode of the optical cavity.

(B6) In the method denoted (B5), the one or more nonlinear emitters includes one or more atoms. Said driving includes driving cavity-vacuum-assisted Raman transitions of the one or more atoms between a first hyperfine ground state and a second hyperfine ground state.

(B7) In any of the methods denoted (B1) to (B6), the one or more nonlinear emitters includes one or more atoms. Said confining comprises trapping the one or more atoms.

(B8) In the method denoted (B7), said trapping includes magnetically trapping the one or more atoms.

(B8) In either of the methods denoted (B7) and (B8), said trapping includes optically trapping the one or more atoms.

(B9) In the method denoted (B8), said optically trapping includes optically trapping the one or more atoms in an intracavity optical dipole trap created by the optical cavity.

(B10) In the method denoted (B9), the method further includes generating the intracavity optical dipole trap by coupling laser light into the optical cavity to excite one or mode longitudinal modes of the optical cavity.

(B11) In the method denoted (B10), the one or more longitudinal modes include two adjacent longitudinal modes of the optical cavity.

(B12) In any of the methods denoted (B8) to (B11), said optically trapping comprises optically trapping a plurality of atoms in the intracavity optical dipole trap. The method further includes driving the plurality of atoms with near-resonant cooling light to induce collisional blockade that removes, from the intracavity dipole trap, pairs of the plurality of atoms. Said driving continues until only one of the plurality of atoms remains in the intracavity optical dipole trap.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1. An optical cavity comprising:
a plurality of mirrors positioned to reflect light along a closed path, first and second mirrors of the plurality of mirrors defining an optical axis therebetween; and
first and second intracavity lenses located along the optical axis;
wherein a mode of the optical cavity has a waist located between the first and second intracavity lenses.

2. The optical cavity of claim 1, having a finesse of less than 1000.

3. The optical cavity of claim 1, the waist being less than ten microns.

4. The optical cavity of claim 1, the first and second intracavity lenses having a similar numerical aperture.

5. The optical cavity of claim 1, each of the first and second intracavity lenses comprising a microscope objective or an aspheric lens.

6. (canceled)

7. The optical cavity of claim 1, one or both of the first and second intracavity lenses having a numerical aperture greater than or equal to 0.5.

8. The optical cavity of claim 1, the plurality of mirrors comprising three or more mirrors forming a ring cavity.

9. The optical cavity of claim 1, the first and second mirrors forming a Fabry-Perot cavity.

10. The optical cavity of claim 9, wherein:
the first mirror and first intracavity lens are separated by a first distance; and
the second mirror and second intracavity lens are separated by a second distance that is different than the first distance.

11-13. (canceled)

14. The optical cavity of claim 1, further comprising a translation stage that, when actuated, translates the first intracavity lens transversely to the optical axis.

15. The optical cavity of claim 14, further comprising a second translation stage that, when actuated, translates the second intracavity lens transversely to the optical axis.

16. The optical cavity of claim 1, further comprising a vacuum chamber within which the first and second intracavity lenses are mounted.

17. The optical cavity of claim 16, the vacuum chamber comprising:
a first vacuum window located between the first intracavity lens and the first mirror; and
a second vacuum window located between the second intracavity lens and the second mirror;
wherein the first and second mirrors are located outside of the vacuum chamber.

18-19. (canceled)

20. A method for cavity quantum electrodynamics, comprising confining one or more nonlinear emitters near the waist of the optical cavity of claim 1.

21. (canceled)

22. The method of claim 20, further comprising reading out the one or more nonlinear emitters using the optical cavity.

23. The method of claim 20, further comprising entangling the one or more nonlinear emitters with a photon that is coupled into the optical cavity.

24. The method of claim 20, further comprising driving the one or more nonlinear emitters to deterministically generating a single photon that is emitted into a mode of the optical cavity.

25. The method of claim 24, wherein:
the one or more nonlinear emitters comprises one or more atoms; and
said driving comprises driving cavity-vacuum-assisted Raman transitions of the one or more atoms between a first hyperfine ground state and a second hyperfine ground state.

26. The method of claim 20, wherein:
the one or more nonlinear emitters comprises one or more atoms; and
said confining comprises trapping the one or more atoms.

27-32. (canceled)
